(19) United States
(12) Patent Application Publication
(10) Pub. No.: US 2024/0005126 A1
(43) Pub. Date: Jan. 4, 2024

(54) Communication of Data for a Model Between Nodes in an Electronic Device

(71) Applicant: Advanced Micro Devices, Inc., Santa Clara, CA (US)

(72) Inventors: Kishore Punniyamurthy, Austin, TX (US); Khaled Hamidouche, Austin, TX (US); Brandon K. Potter, Austin, TX (US); Rohit Shahaji Zambre, Seattle, WA (US)

(21) Appl. No.: 17/853,670

(22) Filed: Jun. 29, 2022

(51) Int. Cl. G06N 3/04; G06N 3/08

(52) U.S. Cl. CPC G06N 3/04; G06N 3/08

(57) ABSTRACT

An electronic device includes one or more data producing nodes and a data consuming node. Each data producing node separately generates two or more portions of a respective block of data. Upon completing generating each portion of the two or more portions of the respective block of data, each data producing node communicates that portion of the respective block of data to the data consuming node. Upon receiving corresponding portions of the respective blocks of data from each of the one or more data producing nodes, the data consuming node performs operations for a model using the corresponding portions of the respective blocks of data.

### BACKGROUND

### Related Art

Some electronic devices perform operations for processing instances of input data through computational models, or “models,” to generate outputs. There are a number of different types of models, for each of which electronic devices generate specified outputs based on processing respective instances of input data. For example, one type of model is a recommendation model. Processing instances of input data through a recommendation model causes an electronic device to generate outputs such as ranked lists of items from among a set of items to be presented to users as recommendations (e.g., products for sale, movies or videos, social media posts, etc.), probabilities that a particular user will click on/select a given item if presented with the item (e.g., on a web page, etc.), and/or other outputs. For a recommendation model, instances of input data therefore include information about users and/or others, information about the items, information about context, etc. FIG. 1 presents a block diagram illustrating a recommendation model 100. Recommendation model 100 includes bottom multilayer perceptron 102, which is a multilayer perceptron that is used for processing continuous inputs 104 in input data. Recommendation model 100 also includes embedding table lookups 106 (a form of generalized linear model), for which categorical inputs 108 in input data are used for performing lookups in embedding tables to acquire lookup data. The outputs of bottom multilayer perceptron 102 and embedding table lookups 106 are combined in interaction 110 to form intermediate values (e.g., by concatenating outputs from each of bottom multilayer perceptron 102 and embedding table lookups 106). From interaction 110, the intermediate values are sent to top multilayer perceptron 112 to be used for generating model outputs 114. One example of a model arranged similarly to model 100 is the deep learning recommendation model (DLRM) described by Naumov et al. in the paper “Deep Learning Recommendation Model for Personalization and Recommendation Systems,” arXiv:1906.00091, May 2019. In some cases, models are used in production scenarios at very large scales. For example, recommendation models may be used for recommending videos to each user among millions of users on a website such as YouTube or for choosing items to be presented each user from among millions of users on a website such as Amazon.

In some electronic devices, multiple compute nodes, or “nodes,” are used for processing instances of input data through models to generate outputs. These electronic devices can include many nodes, with each node including one or more processors and a local memory. For example, the nodes can be or include interconnected graphics processing unit (GPUs) on a circuit board or in an integrated circuit chip, server nodes in a data center, etc. When using multiple nodes for processing instances of input data through models, different schemes can be used for determining where model data is to be stored in memories in the nodes. Generally, model data includes information that describes, enumerates, and/or identifies arrangements or properties of internal elements of a model—and thus defines or characterizes the model. For example, for model 100, model data includes embedding tables for embedding table lookups 106, information about the internal arrangement of multilayer perceptrons 102 and/or 112, and/or other model data. One scheme for determining where model data is stored in memories in the nodes is “data parallelism.” For data parallelism, full copies of model data are replicated/stored in the memory in individual nodes. For example, a full copy of model data for multilayer perceptrons 102 and/or 112 can be replicated in each node that performs processing operations for multilayer perceptrons 102 and/or 112. Another scheme for determining where model data is stored in memories in the nodes is “model parallelism.” For model parallelism, separate portions of model data are stored in the memory in individual nodes. The memory in each node therefore stores a different part—and possibly a relatively small part—of the particular model data. For example, for model 100, a different subset of embedding tables for embedding table lookups 106 (i.e., the model data) can be stored in the local memory of each node among multiple nodes. For instance, given N nodes and M embedding tables, the memory in each node can store a subset that includes M/N embedding tables (M=100, 1000, or another number and N=5, 10, or another number). In some cases, model parallelism is used where particular model data is sufficiently large in terms of bytes that it is impractical or impossible to store a full copy of the model data in any particular node's memory. For example, the embedding tables for model 100 can include thousands of embedding tables that are too large as a group to be efficiently stored in any individual node's memory and thus the embedding tables are distributed among the local memories in multiple nodes.

In electronic devices in which portions of model data are distributed among multiple nodes in accordance with model parallelism, individual nodes may need model data stored in memories in other nodes for processing instances of input data through the model. For example, when the individual embedding tables for model 100 are stored in the local memories of multiple nodes, a given node may need lookup data from the individual embedding tables stored in other node's local memories for processing instances of input data. In this case, each node receives or acquires indices (or other records) that identify lookup data from the individual embedding tables stored in that node's memory that is needed by each other node. The nodes then acquire/look-up and communicate, to each other node, respective lookup data from the individual embedding tables stored in that node's memory (or data generated based thereon, e.g., by combining lookup data, etc.). Given the distribution of the embedding tables for model 100 among all of the nodes as described above, each node must acquire and communicate lookup data to each other node for processing instances of input data through model 100. The communication of the lookup data for model 100 is therefore known as an “all to all communication” due to each node communicating corresponding lookup data to each other node.

FIG. 2 presents a block diagram illustrating an all to all communication for model 100. As can be seen in FIG. 2, node 0 and node N, which are or include elements such as GPU cores or server computers, perform operations for model 100. For the example in FIG. 2, a number of other nodes, i.e., nodes 1 through N−1, are assumed to exist and perform similar operations for model 100, although nodes 1 through N−1 are not shown in FIG. 2 for clarity. For the operations for model 100, each node performs the operations of bottom multilayer perceptron (MLP) 102 based on a respective part of continuous input 200 to generate results BMLP. For example, node 0 receives the zeroth part of continuous input 200 and processes the zeroth part of continuous input 200 through bottom multilayer perceptron 102 to generate node 0's results BMLP. In addition, each node performs embedding table lookups 106 in embedding tables stored in the local memory in that node based on a respective part of categorical input 202 to acquire lookup data to be used in that node and other nodes. For example, node 0 receives category 0 (CATO), which includes indices (or other identifiers) for lookup data 204 to be acquired from the lookup tables stored in a local memory in node 0. After acquiring the lookup data, each node uses a block of the lookup data itself and communicates other respective blocks of the lookup data to other nodes via the all to all communication (COMM). For example, lookup data 204 includes block 00 (i.e., the zeroth block of the lookup data generated by the zeroth node), which is to be used in node 0 itself, as well as blocks 01 through 0N, which are to be used in nodes 1 through N, respectively. As another example, lookup data 206 includes block NN (i.e., the Nth block of the lookup data generated by the Nth node), which is to be used in node N itself, as well as blocks NO through NN−1 (not shown), which are to be used in nodes 0 through N−1. For the all to all communication, node 0 communicates block 01 to node 1, block 0N to node N, etc. and node N communicates block NO to node 0, block N1 to node 1, etc. In other words, each node communicates a respective block of lookup data to each other node via a communication interface coupled between the nodes (e.g., a network, an interface, etc.).

FIG. 3 presents a block diagram illustrating the timing of operations for processing instances of input data through a recommendation model. For the example in FIG. 3, operations performed by node 0 are described. Other nodes, e.g., nodes 1 through N, are not shown in FIG. 3 for clarity, but are assumed to be present and perform similar operations. In addition, although not shown in FIG. 3, continuous inputs are also assumed to be processed in a bottom multilayer perceptron (BOT MLP) to generate results BMLP to be used during interaction 306. As can be seen in FIG. 3, time flows from the top to the bottom of the figure. The first operation in FIG. 3 is embedding table lookups 300, during which node 0 acquires lookup data from embedding tables stored in a local memory in node 0. Node 0 then pools the lookup data in the pooling 302 operation (i.e., prepares the lookup data for all to all communication 304 and/or subsequent use). Node 0 retains a block of the lookup data for its own use and communicates a respective block of the lookup data to each other node during all to all communication (COMM) 304 (e.g., a block of lookup data 0N is communicated to node N, a block of lookup data 01 is communicated to node 1, etc., as shown in FIG. 2). In addition, node 0 receives blocks of lookup data from nodes 1 through N during all to all communication 304. Note that, during embedding table lookups 300, all of the lookup data in respective blocks of lookup data needed by other nodes for processing instances of input data through the model is acquired—and then the full respective blocks of lookup data are communicated to the other nodes during all to all communication 304. Node 0 combines the blocks of lookup data received from the other nodes and its own block of lookup data with results BMLP from bottom multilayer perceptron to generate intermediate data during the interaction 306 operation. Using the intermediate data, node 0 performs operations for top multilayer perceptron 308, during which results from the model are generated.

The acquisition of lookup data from the embedding tables and the subsequent communication of the lookup data during the all to all communication is an operation having a large latency relative to the overall time required for processing instances of input data through the recommendation model. Due to the top multilayer perceptron's data dependencies on the lookup data, each node must wait for the all to all communication to be completed before performing the operations of the top multilayer perceptron, which contributes significant delay to the processing instances of input data through the model.

### BRIEF DESCRIPTION OF THE FIGURES

FIG. 1 presents a block diagram illustrating a recommendation model.

FIG. 2 presents a block diagram illustrating an all to all communication for a recommendation model.

FIG. 3 presents a block diagram illustrating a timing of operations for processing instances of input data through a recommendation model.

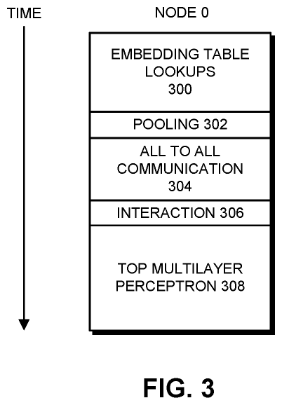

FIG. 4 presents a block diagram illustrating electronic device in accordance with some embodiments.

FIG. 5 presents a block diagram illustrating independent operations for portions of a matrix multiplication in accordance with some embodiments.

FIG. 6 presents a block diagram illustrating operations for pipelining the communication of data between nodes when processing instances of input data through a model in accordance with some embodiments.

FIG. 7 presents a block diagram illustrating the timing of operations for pipelining the communication of data between nodes when processing instances of input data through a model in accordance with some embodiments.

FIG. 8 presents a block diagram illustrating a matrix multiplication using lookup data and weights for a deep neural network (DNN) in accordance with some embodiments.

FIG. 9 presents a flowchart illustrating operations performed in a data producing node for pipelining the communication of data between nodes when processing instances of input data through a model in accordance with some embodiments.

FIG. 10 presents a flowchart illustrating operations performed in a data consuming node for pipelining the communication of data between nodes when processing instances of input data through a model in accordance with some embodiments.

Throughout the figures and the description, like reference numerals refer to the same figure elements.

### DETAILED DESCRIPTION

The following description is presented to enable any person skilled in the art to make and use the described embodiments and is provided in the context of a particular application and its requirements. Various modifications to the described embodiments will be readily apparent to those skilled in the art, and the general principles described herein may be applied to other embodiments and applications. Thus, the described embodiments are not limited to the embodiments shown, but are to be accorded the widest scope consistent with the principles and features described herein.

### Terminology

In the following description, various terms are used for describing embodiments. The following is a simplified and general description of some of the terms. Note that these terms may have significant additional aspects that are not recited herein for clarity and brevity and thus the description is not intended to limit these terms.

Functional block: functional block refers to a set of interrelated circuitry such as integrated circuit circuitry, discrete circuitry, etc. The circuitry is “interrelated” in that circuit elements in the circuitry share at least one property. For example, the circuitry may be included in, fabricated on, or otherwise coupled to a particular integrated circuit chip, substrate, circuit board, or part thereof, may be involved in the performance of specified operations (e.g., computational operations, control operations, memory operations, etc.), may be controlled by a common control element and/or a common clock, etc. The circuitry in a functional block can have any number of circuit elements, from a single circuit element (e.g., a single integrated circuit logic gate or discrete circuit element) to millions or billions of circuit elements (e.g., an integrated circuit memory). In some embodiments, functional blocks perform operations “in hardware,” using circuitry that performs the operations without executing program code.

Data: data is a generic term that indicates information that can be stored in memories and/or used in computational, control, and/or other operations. Data includes information such as actual data (e.g., results of computational or control operations, outputs of processing circuitry, inputs for computational or control operations, variable values, sensor values, etc.), files, program code instructions, control values, variables, and/or other information.

### Models

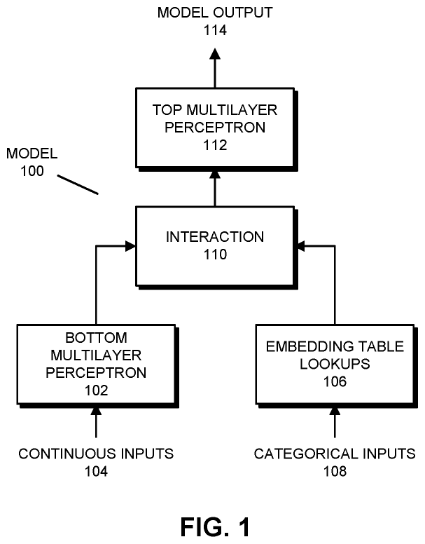

In the described embodiments, computational nodes, or “nodes,” in an electronic device perform operations for processing instances of input data through a computational model, or “model.” A model generally includes, or is defined as, a number of operations to be performed on, for, or using instances of input data to generate corresponding outputs. For example, in some embodiments, the nodes perform operations for processing instances of input data through such as model 100 as shown in FIG. 1. Model 100 is one embodiment of a recommendation model that is used for generating ranked lists of items for presentation to a user, for generating estimates of likelihoods of users clicking on/selecting items presented on a website, etc. For example, model 100 can generate ranked lists of items such as videos on a video presentation website, software applications to purchase from among a set of software applications provided on an Internet application store, etc. Model 100 is sometimes called a “deep and wide” model that uses the combined output of bottom multilayer perceptron 102 (the “deep” part of the model) and embedding table lookups 106 (the “wide” part) for generating the ranked list of items. For example, in some embodiments, model 100 is similar to the deep learning recommendation model (DLRM) described by Naumov et al. in the paper “Deep Learning Recommendation Model for Personalization and Recommendation Systems.”

Models are defined or characterized by model data, which is or includes information that describes, enumerates, and identifies arrangements or properties of internal elements of a model. For example, for model 100, the model data includes embedding tables for use in embedding table lookups 106 such as tables, hashes, or other data structures including index-value pairings; configuration information for bottom multilayer perceptron 102 and top multilayer perceptron 112 such as weights, bias values, etc. used for processing operations for hidden layers within the multilayer perceptrons (not shown in FIG. 1); and/or other model data. In the described embodiments, certain model data is handled using model parallelism (other model data may be handled using data parallelism). Portions of at least some of the model data are therefore distributed among multiple nodes in the electronic device, with separate portions of the model data being stored in local memories in each of the nodes. For example, assuming that model 100 is the model, individual embedding tables for embedding table lookups 106 can be stored in local memories in some or all of the nodes. For instance, given M embedding tables and N nodes, the local memory in each node can store M/N embedding tables (M=1000, 2400, or another number and N=20, 50, or another number).

For processing instances of input data through a model, the instances of input data are processed through internal elements of the model to generate an output from the model. Generally, an “instance of input data” is one piece of the particular input data that is to be processed by the model, such as information about a user to whom a recommendation is to be provided for a recommendation model, information about an item to be recommended, etc. Using model 100 as an example, each instance of input data includes continuous inputs 104 (i.e., dense features) and categorical inputs 108 (i.e., categorical features), which include and/or are generated based on information about a user, context information, item information, and/or other information.

In some embodiments, for processing instances of input data through the model, a number of instances of input data are divided up and assigned to each of multiple nodes in an electronic device to be processed therein. As an example, assume that there are eight nodes and 32,000 instances of input data to be processed. In this case, evenly dividing the instances of input data up among the eight nodes means that each node will process 4000 instances of input data through the model. Further assume that model 100 is the model and that there are 1024 total embedding tables, with a different subset of 128 embedding tables stored in the local memory in each of the eight nodes. For processing instances of input data through the model, each of the eight nodes receives the continuous inputs 104 for all the instances of input data to be processed by that node—and therefore receives the continuous inputs for 4,000 instances of input data. Each node also receives a respective portion of the categorical inputs 108 for all 32,000 instances of input data. The respective portion of the categorical inputs for each node includes a portion of the categorical inputs for which the node is to perform embedding table lookups 106 in locally stored embedding tables. For example, in some embodiments, the categorical inputs 108 include 1024 input index vectors, with one input index vector for each embedding table. In these embodiments, each input index vector includes elements with indices to be looked up in the corresponding embedding table for each instance of input data and thus each of the 1024 input index vectors has 32,000 elements. For receiving the respective portion of the categorical inputs 108 in these embodiments, each node receives an input index vector for each of the 128 locally stored embedding tables with 32000 indices to be looked up in that locally stored embedding table. In other words, in the respective set of input index vectors, each node receives a different 128 of the 1024 input index vectors.

For processing instances of input data through the model, each node uses the respective embedding tables for processing the categorical inputs 108. For this operation, each node performs lookups in the embedding tables stored in that node's memory using indices from the input index vectors to acquire lookup data needed for processing instances of input data. Continuing the example, based on the 32,000 input indices in each of the 128 input index vectors, each node performs 32,000 lookups in each of the 128 locally stored embedding tables to acquire both that node's own data and data that is needed by the other seven nodes for processing their respective instances of input data. Each node then communicates lookup data acquired during the lookups to other nodes in an all to all communication via a communication fabric. For this operation, each node communicates a portion of the lookup data acquired from the locally stored embedding table to the other node that is to use the lookup data for processing instances of input data. Continuing the example from above, each node communicates the lookup data from the 128 locally stored embedding tables for processing the respective 4,000 instances of input data to each other node, so that each other node receives a block of lookup data that is 128×4,000 in size. For example, a first node can communicate a block of lookup data for the second 4,000 instances of input data to a second node, a block of lookup data for the third 4,000 instances of input data to a third node, and so forth—with the first node keeping the lookup data for the first 4,000 instances of input data for processing its own instances of input data. Note that this is a general description of the operations of the model; in the described embodiments, the communication of the lookup data is pipelined with other operations of the model as described below.

In addition to acquiring and communicating the lookup data, each of the nodes processes continuous inputs 104 through bottom multilayer perceptron 102 to generate an output for bottom multilayer perceptron 102. Each node next combines the outputs from bottom multilayer perceptron 102 and that node's lookup data from embedding table lookups 106 in interaction 110 to generate corresponding intermediate values (e.g., combined vectors or other values). For this operation, that node's lookup data includes the lookup data acquired by that node from the locally stored embedding tables as well as all the portions of lookup data received by that node from the other nodes. Continuing the example, as an output of this operation each node produces 4,000 intermediate values, one intermediate value for each instance of input data being processed in that node. Each node processes each of that node's intermediate values through top multilayer perceptron 112 to generate model output 114. The model output 114 for each instance of input data in each node is in the form of a ranked list (e.g., a vector or other listing) of items to be presented to a user as a recommendation, an identification of a probability of a user clicking on/selecting an item presented on a website, etc.

Although a particular model (i.e., model 100) is used as an example herein, the described embodiments are operable with other types of models. Generally, in the described embodiments, any type of model can be used for which separate embedding tables are stored in local memories in multiple nodes in an electronic device (i.e., for which the embedding tables are distributed using model parallelism). In addition, although eight nodes are used for describing processing 32,000 instances of input data through a model in the example above, in some embodiments, different numbers of nodes are used for processing different numbers of instances of input data. Generally, in the described embodiments, various numbers and/or arrangements of nodes in an electronic device can be used for processing instances of input data through a model, as long as some or all of the nodes have a local memory in which separate embedding tables are stored.

### Overview

In the described embodiments, an electronic device includes a number of nodes communicatively coupled together via a communication fabric. Each of the nodes includes at least one processor and a local memory (e.g., a node may include a graphics processing unit (GPU) having one or more GPU cores and a GPU memory). The nodes perform operations for processing instances of input data through a recommendation model arranged similarly to model 100 as shown in FIG. 1. Processing instances of input data through the recommendation model includes using model data for, by, and/or as values for internal elements of the model for performing respective operations. The model data for the recommendation model includes embedding tables for embedding table lookups 106 and model data identifying arrangements and characteristics of elements in bottom multilayer perceptron 102 and top multilayer perceptron 112. As described above, and in accordance with model parallelism, embedding tables for embedding table lookups 106 are distributed among multiple nodes, with a different subset of the embedding tables being stored in the local memory in each of the multiple nodes. When processing instances of input data through the model, the nodes perform an all to all communication via the communication fabric to communicate lookup data acquired from the locally stored embedding tables to one another. The described embodiments perform operations for pipelining operations for the all to all communication of the lookup data from data producing nodes with performing operations for the model using the lookup data in data consuming nodes (i.e., the interaction and top multilayer perceptron operations). For the pipelining, data producing nodes perform at least some operations associated with the all to all communication and data consuming nodes perform at least some of the subsequent operations for the model at substantially the same time. Operations for acquiring lookup data and the all to all communication itself are therefore performed by the data producing nodes partially or wholly in parallel with the data consuming nodes performing the operations for the model.

For the above described pipelining of the all to all communication with the subsequent operations for the model, data producing nodes (i.e., each node, when the embedding tables are stored in the local memory for each node) generate portions of the lookup data associated with the all to all communication. For example, assuming that the nodes are to process N instances of input data (e.g., N=50,000 or another number), the data producing nodes can generate, as the portions of the lookup data, the lookup data for M instances of input data, where M is a fraction of N (e.g., M=5000 or another number). As soon as each portion of the lookup data is generated, each data producing node communicates that portion of the lookup data to data consuming nodes, i.e., to the other nodes. That is, each data producing node performs a remote data communication to communicate each portion of the lookup data to the data consuming nodes as soon as that portion of the lookup data is generated. Upon receiving corresponding portions of the lookup data from each data producing node (i.e., from each other node), the data consuming nodes commence the operations of the model using the corresponding portions of the lookup data. Continuing the example above, therefore, as soon as a given data consuming node receives the corresponding portions of the lookup data from each of the data producing nodes, i.e., the portion of lookup data from each data producing node for the same M instances of input data (e.g., instances 0-4999 of the input data), the given data consuming node performs the interaction and top multilayer perceptron operations for the model. After the data producing nodes have commenced the remote data communication to communicate a given portion of the lookup data to the other nodes, the data producing nodes begin generating next portions of the lookup data to be communicated to the data consuming nodes. The data producing nodes therefore perform the remote data communication of the given portion of the lookup data and the generation of a next portion of the lookup data at least partially in parallel (i.e., at substantially the same time). Meanwhile, the data consuming nodes can be using the corresponding portions of the lookup data to perform the operations of the model. The operations continue in this way, with the data producing nodes generating and promptly communicating portions of the lookup data to the data consuming nodes and the data consuming nodes performing operations of the model, until the data producing nodes have each produced and communicated a final portion of the lookup data to the data consuming nodes.

For the above described pipelining of the all to all communication with the operations for the model, instead of generating all of the lookup data before communicating the lookup data to the other nodes as in existing devices, each data producing node generates independent portions (i.e., fractions, subsets, etc.) of the lookup data that the data producing node separately communicates to data consuming nodes to enable the data consuming nodes to commence operations for the model using the independent portion of the lookup data. In some embodiments, the portions of the lookup data are “independent” in that data consuming nodes are able to perform operations for the model with a given portion of the data— or, rather, with corresponding portions of the data received from each data producing node— without the remaining portions of the block of data. For example, each of the data consuming nodes can combine the corresponding portions of the lookup data with results from the bottom multilayer perceptron for that node to generate intermediate data that can be operated on in the top multilayer perceptron (i.e., can have matrix multiplication and other operations performed using the intermediate data) without requiring that the node have other portions of the lookup data. In some embodiments, the operations for the model performed using the corresponding portions of the lookup data produce a respective portion of an overall output for the model (i.e., model output 114). In other words, and continuing the example from above, the operations of the model produce an output for the M instances of input data. The portion of the overall output of the model can then be combined with other portions of the output of the model that are generated using other portions of the lookup data to form the overall output of the model—or the portion of the overall output of the model can be used on its own.

In some embodiments, each data producing node allocates computational resources for generating a given portion of the lookup data. For example, in some of these embodiments, the data producing nodes can allocate computational resources such as workgroups in one or more GPU cores, threads in one or more central processing unit cores, etc. In these embodiments, when the computational resources have completed generating the given portion of the lookup data, one or more of the computational resources (or another entity) promptly starts a remote data communication of the given portion of the lookup data to the data consuming nodes as described above (e.g., causes a direct memory access functional block to perform the remote data communication). The data producing node can then again allocate the computational resources for generating a next portion of the lookup data—including reallocating some or all of the computational resources for generating the next portion of the lookup data substantially in parallel with the remote data communication of the given portion. In some embodiments, therefore, the portions of lookup data are generated and communicated in a series or sequence. In embodiments, there are sufficient computational resources that two or more groups/sets of computational resources can be separately allocated for generating respective portions of the lookup data—possibly substantially at a same time—so that portions of the lookup data can be generated partially or wholly in parallel and then individually communicated to data consuming nodes. In some embodiments, one or more of the computational resources are configured to perform operations for starting the remote data communication for communicating a given portion of the lookup data once the given portion of the lookup data has been generated. For example, in some embodiments, the one or more of the computational resources can execute a command (or a sequence of commands) that causes a network interface in the data producing node (e.g., a direct memory access (DMA) functional block, etc.) to commence the remote data communication of the given portion of the data.

In some embodiments, a number of the portions of the lookup data that are generated by data producing nodes and separately communicated to data consuming nodes is configurable. In other words, given an overall block of lookup data that is to be communicated to other nodes, the block can be divided into a specified number of portions R (where R=12, 20, or another number). In some of these embodiments, the specified number of portions is set based on a consideration of: (1) the balance between communicating smaller portions of the lookup data to enable relatively high levels of resource utilization for both embedding table lookups and model operations and (2) an amount of communication overhead associated with communicating the portions of the lookup data.

In some embodiments, some or all of the nodes are both data producing nodes and data consuming nodes, in that the nodes both generate and communicate lookup data to other nodes and receive lookup data from the other nodes to be used in operations for the model. In some of these embodiments, the above described allocation of the computational resources includes allocating computational resources from among a pool of available computational resources both for acquiring and communicating portions of lookup data and for performing the operations of the model. This may include respective allocated computational resources acquiring and communicating portions of lookup data and performing the operations of the model substantially in parallel (i.e., partially or wholly at the same time).

In some embodiments, along with pipelining the all to all communication of lookup data for the model, other operations in which the nodes communicate data to one another in a similar fashion can be pipelined. For example, in some embodiments, the communication of data during an all reduce operation when training the model (i.e., during a backpropagation and adjustment of model data such as weights, etc. when training the model) can be pipelined. In these embodiments, the “pipelining” is similar in that portions of data are communicated from data producing nodes to data consuming nodes so that the data consuming nodes can commence operations using the portions of the data.

By pipelining the generation and communication of the portions of the lookup data (or other data for the model) in the data producing nodes with performing the operations of the model using portions of the lookup data in the data consuming nodes, the described embodiments can reduce the latency (i.e., amount of time, etc.) associated with processing instances of input data through the model. By using the rules for determining the number, R, of the portions of the lookup data, some embodiments can balance the busyness of computational resources with the bandwidth requirements for communicating the lookup data. The described embodiments therefore improve the performance of the electronic device, which increases user satisfaction with the electronic device.

### Electronic Device

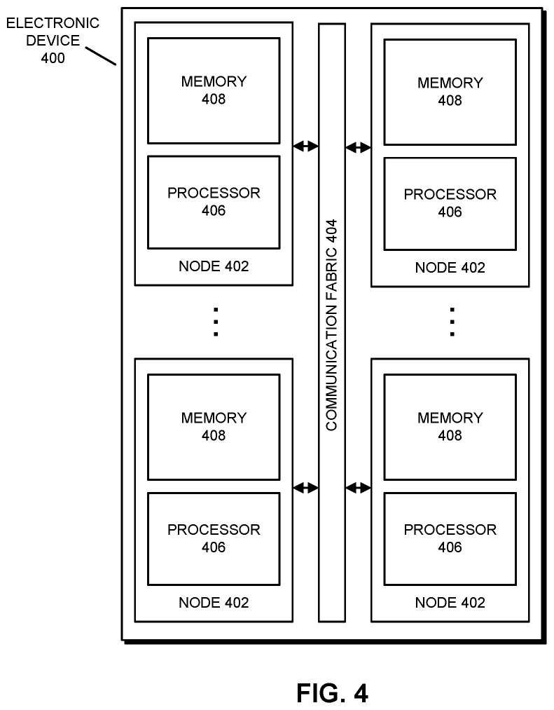

FIG. 4 presents a block diagram illustrating electronic device 400 in accordance with some embodiments. As can be seen in FIG. 4, electronic device 400 includes a number of nodes 402 connected to a communication fabric 404. Nodes 402 and communication fabric 404 are implemented in hardware, i.e., using corresponding integrated circuitry, discrete circuitry, and/or devices. For example, in some embodiments, nodes 402 and communication fabric 404 are implemented in integrated circuitry on one or more semiconductor chips, are implemented in a combination of integrated circuitry on one or more semiconductor chips in combination with discrete circuitry and/or devices, or are implemented in discrete circuitry and/or devices. In some embodiments, nodes 402 and communication fabric 404 perform operations for or associated with pipelining the communication of model data between nodes 402 as described herein.

Each node 402 includes a processor 406. The processor 406 in each node 402 is a functional block that performs computational, memory access, and/or other operations (e.g., control operations, configuration operations, etc.). For example, each processor 406 can be or include a graphics processing unit (GPU) or GPU core, a central processing unit (CPU) or CPU core, an accelerated processing unit (APU), a system on a chip (SOC), a field programmable gate array (FPGA), and/or another form of processor. In some embodiments, each processor includes a number of computational resources that can be used for performing operations such as lookups of embedding table data, model operations for a recommendation model such as model 100 (e.g., operations associated with the bottom multilayer perceptron 102, top multilayer perceptron 112, interaction 110, etc.). For example, the computational resources can include workgroups in a GPU, threads in a CPU, etc.

Each node 402 includes a memory 408 (which can be called a “local memory” herein). The memory 408 in each node 402 is a functional block that performs operations for storing data for accesses by the processor 406 in that node 402 (and possibly processors 406 in other nodes). Each memory 408 includes volatile and/or non-volatile memory circuits for storing data, as well as control circuits for handling accesses of the data stored in the memory circuits, performing control or configuration operations, etc. For example, in some embodiments, the processor 406 in each node 402 is a GPU or GPU core and the respective local memory 408 is or includes graphics memory circuitry such as graphics double data rate synchronous DRAM (GDDR). As described herein, the memories 408 in some or all of the nodes 402 store embedding tables and other model data for use in processing instances of input data through a model (e.g., model 100).

Communication fabric 404 is a functional block and/or device that performs operations for or associated with communicating data between nodes 402. Communication fabric 404 is or includes wires, guides, traces, wireless communication channels, transceivers, control circuitry, antennas, and/or other functional blocks and devices that are used for communicating data. For example, in some embodiments, nodes 402 are or include GPUs and communication fabric 404 is a graphics interconnect and/or other system bus. In some embodiments, portions of lookup data (or other data for a model) are communicated from node to node via communication fabric 404 as described herein.

Although electronic device 400 is shown in FIG. 4 with a particular number and arrangement of functional blocks and devices, in some embodiments, electronic device 400 includes different numbers and/or arrangements of functional blocks and devices. For example, in some embodiments, electronic device 400 includes a different number of nodes 402. In addition, although each node 402 is shown with a given number and arrangement of functional blocks, in some embodiments, some or all nodes 402 include a different number and/or arrangement of functional blocks. Generally, electronic device 400 and nodes 402 include sufficient numbers and/or arrangements of functional blocks to perform the operations herein described.

Electronic device 400 and nodes 402 are simplified for illustrative purposes. In some embodiments, however, electronic device 400 and/or nodes 402 include additional or different functional blocks, subsystems, elements, and/or communication paths. For example, electronic device 400 and/or nodes 402 may include display subsystems, power subsystems, input-output (I/O) subsystems, etc. Electronic device 400 generally includes sufficient functional blocks, subsystems, elements, and/or communication paths to perform the operations herein described. In addition, although four nodes 402 are shown in FIG. 4, in some embodiments, a different number of nodes 402 is present (as shown by the ellipses in FIG. 4).

Electronic device 400 can be, or can be included in, any device that can perform the operations described herein. For example, electronic device 400 can be, or can be included in, a desktop computer, a laptop computer, a wearable computing device, a tablet computer, a piece of virtual or augmented reality equipment, a smart phone, an artificial intelligence (AI) or machine learning device, a server, a network appliance, a toy, a piece of audio-visual equipment, a home appliance, a vehicle, and/or combinations thereof. In some embodiments, electronic device 400 is or includes a circuit board or other interposer to which multiple nodes 402 are mounted or connected and communication fabric 404 is an inter-node communication route. In some embodiments, electronic device 400 is or includes a set or group of computers (e.g., a group of server nodes in a data center) and communication fabric 404 is a wired and/or wireless network that connects the nodes 402. In some embodiments, electronic device 400 is included on one or more semiconductor chips such as being entirely included in a single “system on a chip” (SOC) semiconductor chip, included on one or more ASICs, etc.

### Matrix Multiplication for Independent Portions

In the described embodiments, an electronic device performs operations for pipelining an all to all communication of lookup data for processing instances of input data through a model—or for pipelining other data communication operations for the model (e.g., an all reduce operation, etc.). The “pipelining” includes performing operations for parallelizing the acquisition and communication of the data between the nodes with operations for the model that use the lookup data, so that at least some of the acquisition/communication and the operations for the model can be performed at substantially a same time. In some embodiments, a factor enabling the pipelining of the data communication operations is that portions of the data can be used for operations for the model in data consuming devices independently of other portions of the data. For example, in embodiments where an all to all communication is pipelined for a model such as model 100, operations for the top multilayer perceptron in data consuming devices can be performed using portions of the lookup data independently of other portions of the lookup data. A significant part of the operations for the top multilayer perceptron are the numerous matrix multiplication operations (or fused multiply adds, etc.) that are computed to generate inputs to activation functions in a deep neural network (DNN) of the top multilayer perceptron (e.g., rectified linear units, etc.). That is, matrix multiplication operations that are performed for multiplying weight values by inputs to activation functions for intermediate nodes in the DNN for the top multilayer perceptron. The matrix multiplications are independent for different portions of the lookup data, in that the values in each portion of the data can be multiplied without relying on values in other portions of the lookup data.

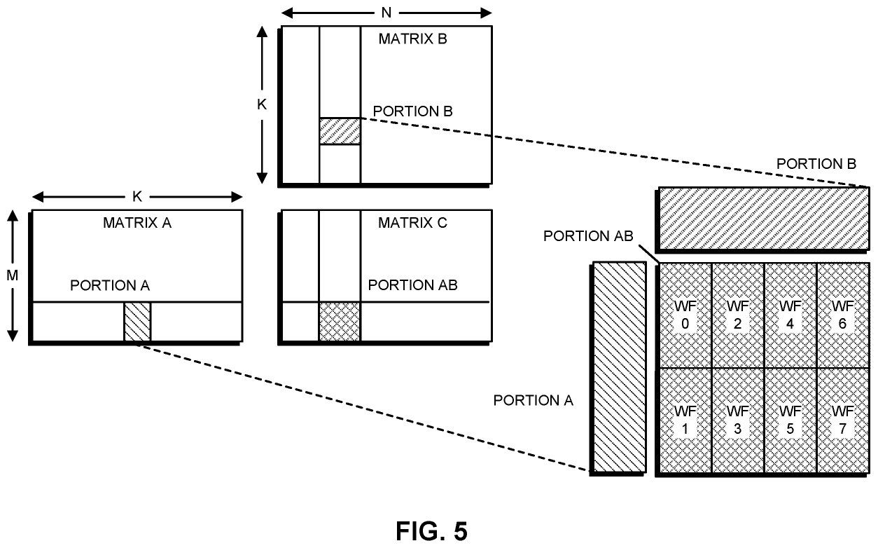

FIG. 5 presents a block diagram illustrating independent operations for portions of a matrix multiplication in accordance with some embodiments. For the matrix multiplication operation in FIG. 5, a M×K matrix A is to be multiplied by a K×N matrix B to generate an M×N matrix C. Given the nature of the matrix multiplication, different internal portions (i.e., blocks, subsections, parts, etc.) can be independently multiplied by one another to form separate results. The separate results can then be combined together to form the matrix C. In other words, matrix C can be computed in pieces by cycling through different portions from the matrix A and the matrix B and computing the respective part of the matrix C. An example of such portions is shown as portions A and B in FIG. 5. When portion A and portion B are multiplied they form portion AB as shown in the matrix C.

In some embodiments, the multiplication of portions A and B can be further divided so that two or more computational resources perform respective operations for the multiplication, possibly substantially in parallel (i.e., partially or wholly at a same time). A number of wavefronts (WF) of a GPU is shown as an example in FIG. 5, although other computational resources can be used in some embodiments (e.g., CPU cores, threads in one or more CPU cores, circuitry in an ASIC, etc.). As can be seen in FIG. 5, eight wavefronts in a GPU (which may be scheduled as part of a workgroup that computes portion AB), wavefronts 0-7, compute the corresponding parts/divisions of portion AB based on portions A and B. The results of the matrix multiplication operation for each of the wavefronts are then combined to form portion AB of the matrix C. In some cases, some or all of the computational resources are then reallocated to perform the matrix multiplication for next portions of the matrix A and matrix B until the full matrix C is generated.

### Pipelining Communication of Data in Nodes in an Electronic Device

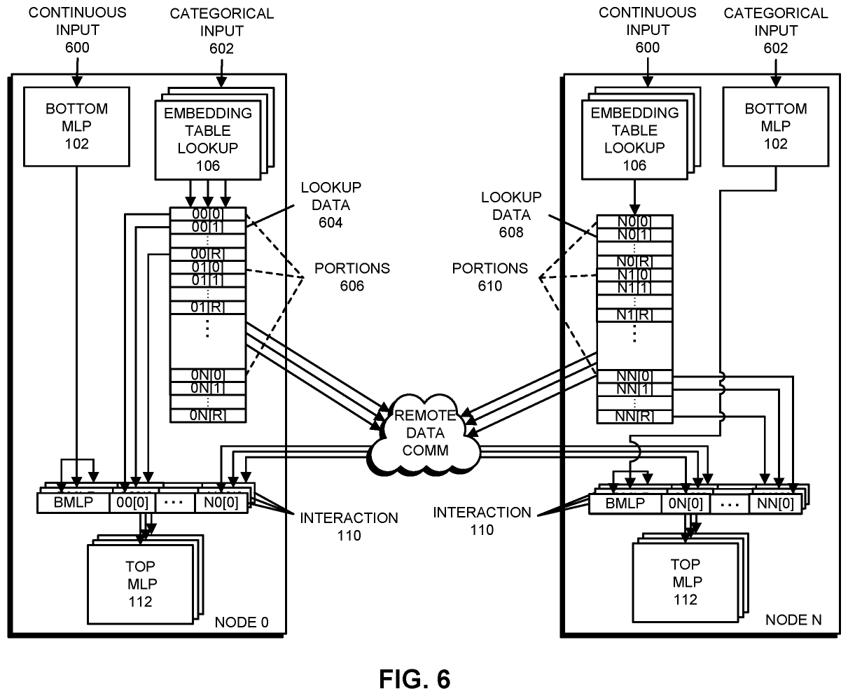

In the described embodiments, nodes in an electronic device perform operations for pipelining communication of data between the nodes when processing instances of input data through a model. FIG. 6 presents a block diagram illustrating operations for pipelining the communication of data between nodes when processing instances of input data through a model in accordance with some embodiments. FIG. 6 is presented as general example of operations performed in some embodiments. In other embodiments, however, different operations are performed and/or operations are performed in a different order. Additionally, although certain elements are used in describing the operations in FIG. 6, in some embodiments, other elements perform the operations.

For the example in FIG. 6, an electronic device having N+1 nodes is assumed to perform operations for a deep learning recommendation model (DLRM) similar to model 100. The model described for FIG. 6 therefore includes operations for a bottom multilayer perceptron, embedding table lookups, an all to all communication, etc. It is also assumed that embedding tables for the model are distributed among the N+1 nodes in accordance with model parallelization. For example, given M embedding tables, the local memory in each node can store M/(N+1) embedding tables (M=500, 2500, or another number and N+1=10, 50, or another number). The communication of data therefore involves the all to all communication of lookup data acquired from embedding tables in the local memory in data producing nodes to data consuming nodes for use in interaction and top multilayer perceptron operations in the data consuming nodes. Although only nodes 0 and N are shown in FIG. 6 for clarity, other nodes among the N+1 nodes, i.e., nodes 1 through N−1, are assumed to perform similar operations for the model (some of the other nodes are described in the description of FIG. 6).

For the example in FIG. 6, each node is both a data producing node and a data consuming node. Each node therefore acquires portions of lookup data stored in a local memory in that node to be communicated to other nodes for the all to all communication. Each node also performs the other operations of the model, i.e., the interaction and top multilayer perceptron operations, using portions of lookup data that that node acquires from the embedding tables stored in its own local memory and portions of lookup data received from other nodes.

For the example, in FIG. 6, data producing nodes acquire portions (i.e., subsets, parts, divisions, etc.) of respective blocks of lookup data from the locally stored embedding tables and then promptly communicate each of the portions of the respective blocks of lookup data to data consuming nodes as soon as each portion of the respective block of lookup data has been acquired (i.e., generated, pooled, and/or otherwise prepared) via a remote data communication. For example, assuming that 6000 instances of input data are to be processed through the model, each of the portions of the lookup data can include lookup data for a respective 300, 600, or another number of the 6000 instances of input data. Upon receiving corresponding portions of the lookup data from each data producing node (i.e., all of the portions of the lookup data from the data producing nodes for the same instances of input data), the data consuming nodes promptly commence using the corresponding portions of the lookup data for the interaction and top multilayer perceptron operations. As or after each portion of the lookup data is communicated to the data consuming nodes, the data producing nodes commence acquiring next portions of the lookup data. The data producing nodes acquire (and communicate) the next portions of the lookup data at substantially at the same time as the data consuming nodes use the portions for the interaction and top multilayer perceptron operations. In this way, the acquisition and communication of the next portions of the lookup data is performed substantially in parallel with—and thus “pipelined” with—the use of previously-acquired portions by the data consuming nodes. In some implementations, the pipelining further includes a data producing node commencing the remote data communication for a given portion of the lookup data (e.g., via a direct memory access (DMA) functional block) and subsequently commencing acquiring a next portion of the lookup data substantially in parallel with the remote data communication of the given portion—thereby “pipelining” its own acquisition and communication operations.

As can be seen in FIG. 6, for the operations for the model, each node performs the operations of bottom multilayer perceptron (MLP) 102 based on a respective portion of continuous input 600 to generate results BMLP. For example, node 0 receives a zeroth portion of continuous input 600 and processes the zeroth portion of continuous input 600 through bottom multilayer perceptron 102 to generate node 0's BMLP. In some embodiments, each node performs the operations for bottom multilayer perceptron 102 in a continuous single operation. For example, a given node can allocate computational resources such as workgroups on a GPU, threads on a CPU, etc. to perform the operations until all of the results BMLP for bottom multilayer perceptron 102 have been generated. In some embodiments, however, the results BMLP of the bottom multilayer perceptron are generated as needed—i.e., portions of the results BMLP are generated as they are needed for processing portions of lookup data in interaction 110. For the example in FIG. 6, it is assumed that each node generates the results BMLP in a single operation and then uses results BMLP in the interaction 110 as needed. This is shown in FIG. 6 as a forking of the arrow from bottom multilayer perceptron 102 to interaction 110, with one fork/arrow for each of the three illustrated interaction 110 operations.

For the operations of the model, each node also performs embedding table lookups 106 in embedding tables stored in the local memory in that node based on a respective portion of categorical input 602 to acquire a block of lookup data to be used in that node and respective blocks of lookup data to be communicated to other nodes. For this operation, each block of lookup data is logically divided into R portions (where R=10, 16, or another number) so that each portion includes a subset of that block of lookup data. For example, in some embodiments, each node evenly divides (to the extent possible) indices in the input index vector into R portions, with each of the R portions having approximately a same number of indices. Each node uses the respective input indices to perform the lookups in the embedding tables for each of the R portions. Some examples of portions of lookup data are shown in lookup data 604 and lookup data 608 in FIG. 6. Each portion of lookup data in lookup data 604 and 608 is shown with a label in the format: (1) data producing node, (2) data consuming node, and (3) a portion identifier. For example, node 0 generates, among zeroth portions 606, lookup data 00[0], which is lookup data that was generated by the zeroth data producing node, is destined for the zeroth data consuming node, and belongs to the zeroth portion. The lookup data is therefore acquired in node 0 and destined to be used in node 0 along with zeroth portion data received from other nodes in the interaction and top multilayer perceptron operations. Node 0 also generates, among zeroth portions 606, lookup data 01[0], which is lookup data that was generated by the zeroth data producing node, is destined for the first data consuming node (not shown), and belongs to the zeroth portion. Node 0 additionally generates, for among zeroth portions 606, lookup data 0N[0], which is lookup data that was generated by the zeroth data producing node, is destined for the Nth data consuming node, and belongs to the zeroth portion. Node N performs similar operations for generating zeroth portions 610, which is the corresponding zeroth portion of the lookup data generated in node N and includes lookup data N0[0], N1[0], and NN[0].

After acquiring each portion of the respective block of lookup data for each other node, each node promptly communicates that portion of the respective block of lookup data to each other node. For example, node 0 generates each portion of the respective block of lookup data (i.e., acquires the lookup data for that portion, pools the lookup data for that portion, and/or otherwise prepares the lookup data for that portion) and then substantially immediately communicates that portion of the respective block of lookup data to each other node. Each node then returns to generating a next portion (if any) of the respective block of lookup data. For example, node 0 can generate the zeroth portion, which includes lookup data 00[0], 01[0], 0N[0], etc., and promptly communicate the zeroth portion of the respective block of lookup data to each other node by communicating lookup data 01[0] to the first node, lookup data 0N[0] to the Nth node, etc. —and keep its portion of its own block of lookup data, i.e., lookup data 00[0]. As or after communicating the zeroth portion to the other nodes, node 0 can commence generating the first portion of the respective block of lookup data, i.e., the next portion of the respective block of lookup data, which includes which includes lookup data 00[1], 01[1], 0N[1], etc. In some implementations, therefore, node 0 commences the remote data communication for the zeroth portion and subsequently commences acquiring a first portion of the lookup data substantially in parallel with the remote data communication of the zeroth portion—so that the communication and acquisition operations at least partially overlap. Node 0 can continue in this way, generating and then communicating the portions of the respective blocks of lookup data, until all of the portions of the respective blocks of lookup data have been generated and communicated to the other nodes. That is, node 0 can generate and communicate the portions until generating and communicating the Rth portion of the respective block of lookup data, which includes which includes lookup data 00[R], 01[R], 0N[R], etc. Note that this differs from existing electronic devices, in which each respective block of lookup data is fully generated and then communicated in a single all to all communication to each other node.

Upon receiving corresponding portions of the respective blocks of lookup data from the other nodes, each node processes the corresponding portions the respective blocks of lookup data and a corresponding portion of its own respective block of lookup data through the interaction 110 operation to generate intermediate data. Using the zeroth portion as an example, therefore, upon generating or receiving the zeroth portion of each of the respective blocks of lookup data, i.e., 00[0], 10[0] (not shown), N0[0], etc., node 0 commences the interaction operation for the zeroth portion. For example, each node can arrange the results BMLP and the zeroth portions of the respective blocks of lookup data into intermediate data such as a vector input for the top multilayer perceptron 112 operation. For instance, in some embodiments, node can concatenate the results BMLP associated with the zeroth portion and each of lookup data 10[0], N0[0], etc. (or values computed based thereon) to generate the intermediate data.

Each node then uses the intermediate data from the interaction 110 operation in the top multilayer perceptron 112 operation. As described above, the top multilayer perceptron 112 includes operations for a deep neural network (DNN) and thus involves a number of matrix operations (e.g., multiplications, fused multiply adds, etc.) for using the intermediate data to generate an output for the DNN— and thus the model. Using node 0 as an example, intermediate data generated from the zeroth portions of the respective blocks of lookup data is processed through the DNN to generate the outputs of the model. As described above, because each of the portions of the respective blocks of lookup data are independent, the matrix operations can be performed using intermediate data without reliance on other portions of the respective blocks of lookup data—or, rather, intermediate data generated therefrom.

As can be seen in FIG. 6, there are multiple arrows between various figure elements. Generally, the use of multiple arrows is to illustrate that the operations are performed multiple times. More specifically, the operations are performed for each of the R portions of the respective blocks of lookup data. As an example of the use of the multiple arrows, the separate generation of the portions of the respective blocks of lookup data is illustrated in FIG. 6 via multiple arrows from embedding table lookup 106 to the lookup data in nodes 0 and N. The separate communication of the portions of the respective block of lookup data from each node to the other nodes is also illustrated in FIG. 6 via multiple arrows from the lookup data in each node to the remote data communication (COMM) representation between the nodes (i.e., the representation of an interface or network upon which the remote data communication is performed)—and the corresponding multiple arrows from the remote data communication representation to the corresponding interaction 110 in each node. For example, for the zeroth portion, which includes lookup data 0N[0], etc., lookup data 0N[0] is communicated from node 0 to node N, where lookup data 0N[0] is used in the interaction 110 for the zeroth portion along with lookup data including NN[0], BMLP, etc. In addition, the zeroth portion includes lookup data 00[0], which node 0 itself retains/keeps and uses in the interaction 110 for the zeroth portion along with lookup data including N0[0], BMLP, etc. The obscured versions of the interaction illustrate the interaction operation for subsequent portions, i.e., the first portion through the Rth portion. Although a number of arrows and figure elements are shown in FIG. 6 as an example of the remote data communication of portions of the respective blocks of data, in some embodiments, a different number or arrangement of arrows and figure elements (and thus underlying operations) is performed. Generally, in the described embodiments, the remote data communication is pipelined with subsequent operations for the model (e.g., the interaction and top multilayer perceptron operations) as described elsewhere herein. Note that the “remote data communication” is a scatter communication or another form of communication between nodes in which portions of lookup data are communicated from a given data producing node to each data consuming node.

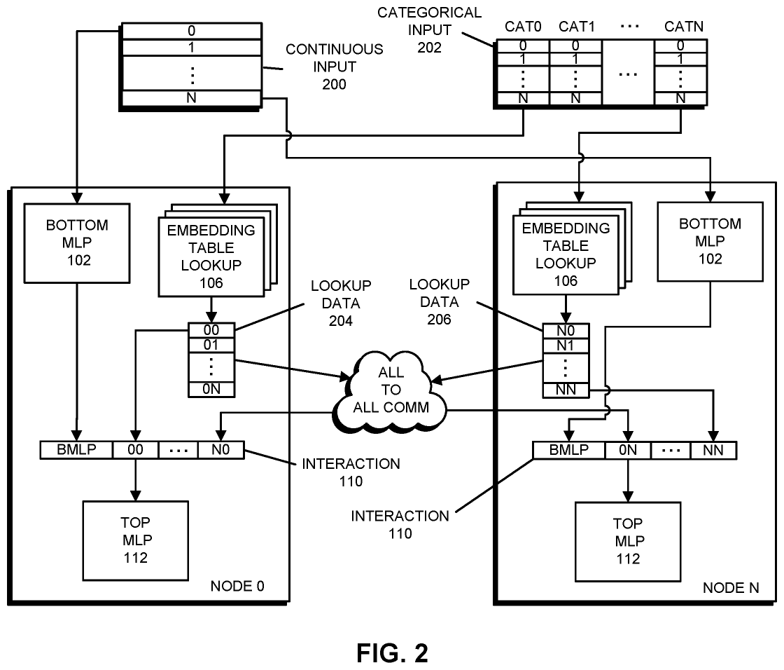

Note that, in comparison to lookup data 204 and 206 in FIG. 2, the lookup data for the example in FIG. 6 is divided into R portions, which are handled by nodes 0 and N as described above. For example, the lookup data shown as 00 in node 0 in FIG. 2 is divided into zeroth through Rth portions in FIG. 6. Only a few of the portions, however, are shown in FIG. 6 for clarity, i.e., zeroth, first, and Rth portions-00[0], 00[1], and 00[R]. As another example, the lookup data shown as NO in node N in FIG. 2 is divided into zeroth through Rth portions in FIG. 6. Again, only a few of the portions, i.e., zeroth, first, and Rth portions, are shown in FIG. 6 as N0[0], N0[1], and N0[R] for clarity. As described herein, this division of the respective block of lookup data for each node into portions enables the pipelining of the communication of the lookup data with operations of the model that rely on the respective portions of the lookup data—as well as the pipelining of the acquisition and communication operations for the separate portion of the lookup data within the data producing nodes.

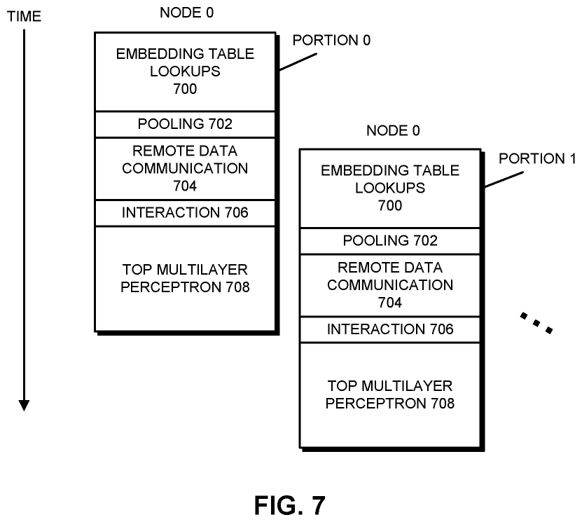

FIG. 7 presents a block diagram illustrating the timing of operations for pipelining the communication of data between nodes when processing instances of input data through a model in accordance with some embodiments. Generally, FIG. 7 is a timing diagram illustrating the timing of specified operations for a DLRM such as model 100 such as that described above for FIG. 6. FIG. 7 is presented as general example of operations performed in some embodiments. In other embodiments, however, different operations are performed and/or operations are performed in a different order. Additionally, although certain elements are used in describing the operations in FIG. 7, in some embodiments, other elements perform the operations.

For the example in FIG. 7, operations performed by node 0 are described. Other nodes, e.g., nodes 1 through N, are not shown in FIG. 7 for clarity, but are assumed to be present and perform similar operations. Also, FIG. 7 includes only two sequences of operations for two different portions of respective blocks of lookup data, portions 0 and 1. Although there are only two sequences of operations shown, in some embodiments, similar sequences of operations are performed for other portions, e.g., portions 2 through R (where R=10, 25, or another number). In some embodiments, the subsequent sequences of operations (following the sequence of operation for portion 1) are offset in a similar way—i.e., start during (or after) the previous sequences' remote data communication as shown for the zeroth and first sequences. Although not shown in FIG. 7, continuous inputs are assumed to be processed in a bottom multilayer perceptron (BOT MLP) to generate results BMLP to be used during interaction 706. As can be seen in FIG. 7, time flows from the top to the bottom of the figure.

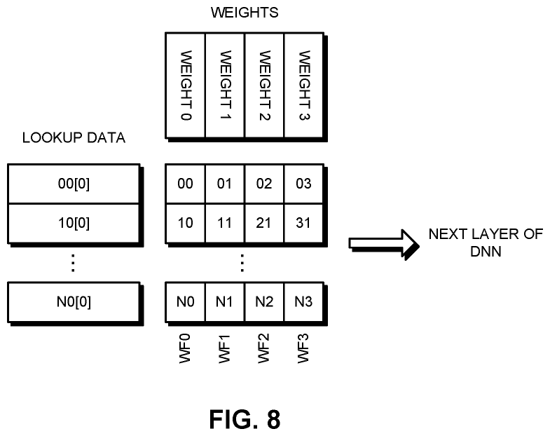

For the zeroth/left sequence of operations for portion 0, node 0 first performs embedding table lookups 700 in embedding tables stored in the local memory of node 0 to acquire the zeroth portion of the respective block of lookup data for each node, itself included. Node 0 then performs the pooling 702 operation for the zeroth portions (i.e., prepares the lookup data for remote data communication 704 and/or subsequent use). Node 0 next communicates the zeroth portions of the respective blocks of data to each other node, i.e., to nodes 1 through N— and retains the zeroth portion of its own block of data. Node 0 also receives, from each other node, a zeroth portion of a respective block of data for node 0 (i.e., “corresponding” portions of the respective blocks of data). Node 0 then uses the results BMLP and the zeroth portions of the respective blocks of data in the interaction 706 operation for generating intermediate data to be used in the top multilayer perceptron 708 operation. Node 0 next uses the intermediate data in the top multilayer perceptron 708 operation for generating results/outputs from the model. The top multilayer perceptron 708 operation includes performing matrix operations (e.g., matrix multiplications, fused multiply adds, etc.) using the intermediate data and/or values generated therefrom to compute input values for activation functions in a DNN in the top multilayer perceptron. For example, FIG. 8 presents a block diagram illustrating a matrix multiplication using lookup data and weights for a DNN in accordance with some embodiments. As can be seen in FIG. 8, a number of wavefronts (WF0-WF3) in node 0 (which can be scheduled as part of a workgroup) perform matrix multiplication operations using portions of the respective block of lookup data acquired locally (00[0]) or received from other nodes (10[0] through N0[0])— or values computed based thereon—and weights for the DNN, which are then combined to form values for activation functions in the next layer of the DNN (similarly to what is described above for FIG. 5).

For the first/right sequence of operations for portion 1, note that the sequence of operations commences during the remote data communication of the zeroth portions of the respective blocks of data. Node 0 therefore commences embedding table lookups 700 for the first sequence as the remote data communication is being performed for the zeroth sequence. For example, node 0 may allocate a first set of computational resources (e.g., workgroups in a GPU, threads in a CPU, etc.) to perform the embedding table lookups 700 and pooling 702 operations for the zeroth sequence and then initiate the remote data communication 704 for the zeroth sequence (e.g., by commanding a direct memory access functional block to perform the communication) before continuing with the operations of the zeroth sequence. Node 0 may then allocate a second set of computational resources to perform the operations for the first sequence during the remote data communication for the zeroth sequence.

Although node 0 is described as starting the first sequence of operations during the remote data communication for the zeroth sequence, in some embodiments, node 0 waits until the remote data communication 704 for the zeroth sequence of operations is completed before starting the second set of computational resources on the first sequence of operations. Generally, however, at least some operations of the embedding table lookups 700, pooling 702, and/or remote data communication 704 for the first sequence are performed substantially in parallel with the interaction 706 and/or top multilayer perceptron 708 operations for the zeroth sequence. In addition, although particular sets of computational resources are being described as being allocated for and performing specified operations, in some embodiments, different sets of computational resources perform different operations. For example, a given set of computational resources may perform the embedding table lookups 700, pooling 702, and commence the remote data communication 704 operations (e.g., by sending a command to a direct memory access (DMA) functional block) for each portion and then be reallocated for performing these operations for the next portion. In other words, the given set of computational resources may perform the first “half” of the sequence of operations. In these embodiments, another set of computational resources may perform the interaction 706 and top multilayer perceptron 708 operations for one or more sequences—i.e., may be dynamically allocated to perform the second “half” of the sequence of operations.

For the first sequence of operations for portion 1, node 0 first performs embedding table lookups 700 in embedding tables stored in the local memory of node 0 to acquire the first portion of the respective block of lookup data for each node, itself included. Node 0 then performs the pooling 702 operation for the first portions (i.e., prepares the lookup data for remote data communication 704 and/or subsequent use). Node 0 next communicates the first portions of the respective blocks of data to each other node, i.e., to nodes 1 through N—and retains the first portion of its own block of data. Node 0 also receives, from each other node, a first portion of a respective block of data for node 0 (i.e., “corresponding” portions of the respective blocks of data). Node 0 then uses the results BMLP and the first portions of the respective blocks of data in the interaction 706 operation for generating intermediate data to be used in the top multilayer perceptron 708 operation. Node 0 next uses the intermediate data in the top multilayer perceptron 708 operation for generating results/outputs from the model. The top multilayer perceptron 708 operation includes performing matrix operations (e.g., matrix multiplications, fused multiply adds, etc.) using the intermediate data and/or values generated therefrom to compute input values for activation functions in a DNN in the top multilayer perceptron.

### Allocation of Computational Resources

In the described embodiments, nodes in an electronic device perform operations for pipelining communication of model data between the nodes. In some embodiments, each of the nodes includes a set of computational resources. Generally computational resources include circuitry that can be allocated for performing operations in the nodes. For example, computational resources can be or include workgroups in a GPU, threads in a CPU, processing circuitry in an ASIC, etc. In some embodiments, the computational resources can be dynamically allocated (i.e., allocated and reallocated as needed) for performing the operations for pipelining the communication of data between the nodes. For example, workgroups in a GPU can be allocated for performing the embedding table lookups, the interaction operation, the top multilayer perceptron operation, etc. In some embodiments, due to the parallelization of the acquisition and communication of portions of lookup data with the interaction and top multilayer perceptron operations, different sets of computational resources can be assigned for performing each of these operations. For example, a first set of computational resources might be allocated for performing the embedding table lookups, pooling, and remote data communication operations, while a second set of computational resources is allocated for performing the interaction and top multilayer perceptron operations. Generally, in the described embodiments, nodes include groups or sets of computational resources that can be assigned for performing desired operations for processing instances of input data through the model.

### Number of Portions

Recall that, for pipelining the communication of lookup data between the nodes, blocks of lookup data are logically divided into R portions (where R=13, 17, or another number) so that each portion includes a subset of that block of lookup data. For example, the block of lookup data for node 0 can be divided into R portions as shown in FIG. 6, so that node 0 acquires lookup data for zeroth, first, and up to Rth portions (i.e., 00[0], [00[1], . . . 00[R]). In some embodiments, the value of R, i.e., the number of portions of the lookup data, is configurable—and possibly dynamically configurable (i.e., settable and resettable during operation of the electronic device). In some of these embodiments, the specified number of portions is set based on a consideration of the balance between: (1) communicating smaller portions of the lookup data to enable relatively high levels of resource utilization for both embedding table lookups and model operations and (2) an amount of communication overhead associated with communicating the portions of the lookup data. Generally, the specified number of portions is set based on properties of the block of lookup data (e.g., overall size, individual data piece data sizes, etc.), properties of the data consuming node (e.g., speed of model operations, maximum data intake rates, etc.), and/or properties of the data producing node (e.g., speed of lookup data generation, maximum data transmission rates, etc.). In some embodiments, the number of portions can be dynamically updated based on one or more rules, such as rules relating to resource utilization rates or idle times in the data producing and/or data consuming nodes, communication interface bandwidth availability, etc.

### Processes for Pipelining Communication of Model Data

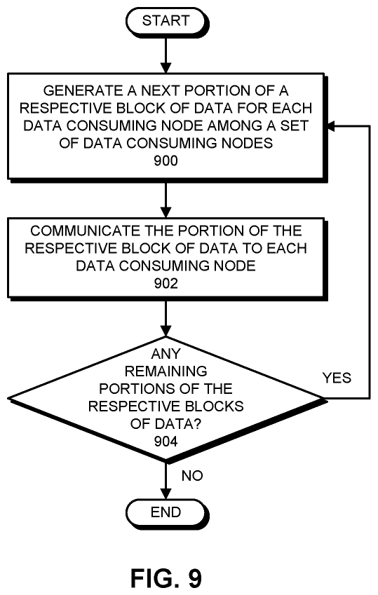

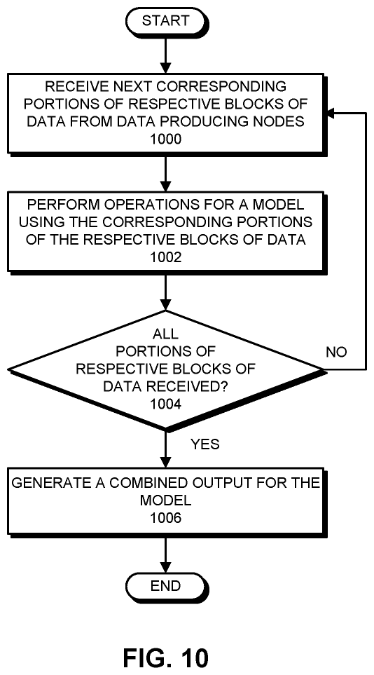

In the described embodiments, nodes in an electronic device perform operations for pipelining communication of data between the nodes when processing instances of input data through a model. FIGS. 9 and 10 present flowcharts illustrating operations in a data producing and data consuming node, respectively, for pipelining the communication of data. More specifically, FIG. 9 presents a flowchart illustrating operations performed in a data producing node for pipelining the communication of data between nodes when processing instances of input data through a model in accordance with some embodiments. FIG. 10 presents a flowchart illustrating operations performed in a data consuming node for pipelining the communication of data between nodes when processing instances of input data through a model in accordance with some embodiments. FIGS. 9-10 are presented as general examples of operations performed in some embodiments. In other embodiments, however, different operations are performed and/or operations are performed in a different order. Additionally, although certain elements are used in describing the processes, in some embodiments, other elements perform the operations.

For the examples in FIGS. 9-10, an electronic device is assumed to have N+1 nodes. The nodes, i.e., computational resources therein, perform operations for processing instances of input data through a deep learning recommendation model (DLRM) (e.g., model 100) that includes a set of embedding tables in which data for the model is stored. The embedding tables are distributed among the nodes in accordance with model parallelization so that a local memory in each node stores a different subset of the embedding tables. For the examples in FIGS. 9-10, a single node is described as performing various operations, although other nodes are assumed to perform similar operations and/or other operations for processing instances of input data through the model. For the examples in FIGS. 9-10, each of the N+1 nodes is assumed to be both a data producing node and a data consuming node, in that each node acquires, generates, etc. data to be communicated to each other node and each node receives and uses data from each other node.

The process in FIG. 9 starts when a data producing node generates a portion of a respective block of data for each data consuming node among a set of data consuming nodes (step 900). For this operation, the data producing node performs lookups in embedding tables stored in the local memory of the data producing node to acquire a portion of lookup data for a respective block of data for each data consuming node. For example, node 0 as shown in FIG. 6 can perform lookups in the embedding tables to acquire lookup data for the zeroth portion of respective blocks of lookup data for the data consuming nodes—which is shown as lookup data 01[0], . . . 0N[0] in FIG. 6. In some embodiments, step 900 includes operation similar to embedding table lookups 700 and pooling 702 as shown in FIG. 7.

The data producing node then promptly communicates the portion of the respective block of data to each data consuming node (step 902). For this operation, the data producing node communicates the portion of the respective block of data for each data consuming node to that data consuming node via a remote data communication (e.g., a scatter communication including a separate communication a portion between the data producing node and each data consuming node). For example, node 0 as shown in FIG. 6 can communicate zeroth portions of the respective blocks of lookup data to the other nodes by communicating lookup data 01[0] to node 1, lookup data 0N[0] to node N, etc. In some embodiments, step 902 includes operation similar to remote data communication 704 as shown in FIG. 7.

Note that the data producing node “promptly” communicates the portions of the respective blocks of lookup data to the data consuming nodes in that the data producing node communicates the portions starting substantially immediately after the portions are generated—and possibly before generating remaining portions (if any) of the respective block of data for each data consuming node. This enables data consuming nodes to commence subsequent operations for the model (as described for FIG. 10) for the portion while a subsequent portion (if any) is generated in the data producing node and communicated to the data consuming nodes.

If there are any remaining portions of the respective blocks of data to be generated and communicated to the data consuming nodes (step 904), the data producing node returns to step 900 to generate the next portion. Note that, although steps 902 and 904/906 are shown as a series or sequence, in some implementations, a data producing node commences, starts, initiates etc. the remote data communication of the portion of the respective block of data for step 902 (such as by triggering a DMA functional block to perform the remote data communication) and then immediately proceeds to steps 904/906 to generate a next block of data (assuming that there is a next block of data). In this way, in these implementations, step 902 for a block of data and step 900 for a next block of data are performed at least partially in parallel—so that the operations for generating and communicating the blocks of data are “pipelined.” Otherwise, when all the portions have been generated and communicated (step 904), the process ends.

The process in FIG. 10 starts when a data consuming node receives next corresponding portions of respective blocks of data from data producing nodes (step 1000). For this operation, the data consuming node receives a portion of a block of lookup data from each data producing node (including the data consuming node itself). The block of lookup data includes all of the lookup data to be communicated from a given data producing node to the data consuming node and thus the portion is a part, subsection, or division of that block of lookup data. For example, node 0 as shown in FIG. 6 can receive, from each of node 1 through node N, a zeroth portion of the block of data to be communicated from that node to node 0. Node 0 therefore receives lookup data 10[0] from node 1, lookup data N0[0] from node N, etc. Node 0 also itself generates lookup data 00[0]— and thus “receives” this lookup data internally. In some embodiments, the data received by node 0 is acquired and communicated by each of node 1 through node N as is described above for FIG. 9.

The “corresponding” portions of the respective blocks of lookup data include the same portions from each respective block of lookup data—i.e., the portions of the lookup data from each node to be used for processing a given set of instances of input data (e.g., instances 0-99 of 1000 instances of input data, etc.). For example, when node 0 is the data consuming node and the zeroth portion is the portion, the corresponding portions of the respective blocks of lookup data include lookup data 00[0], 10[0], N0[0], etc. Generally, the corresponding portions are portions of the respective blocks of lookup data that are needed for the subsequent operations of the model, i.e., the interaction and top multilayer perceptron operations for the model. Recall, therefore, that the corresponding portions of the respective blocks of data include independent portions of the respective blocks of data to be used for matrix operations (e.g., matrix multiplication, fused multiply add, etc.) for the top multilayer perceptron.

The data consuming node then performs operations for the model using the corresponding portions of the respective blocks of data (step 1002). For this operation, the data consuming node performs the interaction operation to generate intermediate data that is then used in the top multilayer perceptron operation, as is shown in FIGS. 6-7. Node 0 therefore receives each of lookup data 00[0], 10[0], N1[0], etc. and combines the lookup data with the results BMLP from the bottom multilayer perceptron to generate intermediate data (e.g., input vectors, etc.). Node 0 then processes the intermediate data in a DNN for top multilayer perceptron to generate outputs/results from the model for the zeroth portion.

If there are any remaining portions of the respective blocks of data to be received by the data consuming node (step 1004), the data consuming node returns to step 1000 receive the next portions of the respective blocks of data. Otherwise, when all the portions have been received (step 1004), the data consuming node generates a combined output for the model (step 1006). For this operation, the data consuming node combines outputs of the model generated using each portion so that a combined output of the model can be produced.

### Pipelining for Other Types of Data

In some embodiments, along with pipelining the all to all communication of lookup data for the model, other operations in which the nodes communicate data to one another in a similar fashion can be pipelined. For example, in some embodiments, the communication of data during an all reduce operation when training the model (i.e., during a backpropagation and adjustment of model data such as weights, etc. when training the model) can be pipelined. Generally, the described embodiments can pipeline various types of operations in which data is communicated from nodes to other nodes similarly to the all to all and all reduce communications. In other words, where portions/subsets of blocks of data such as the above described lookup data can be generated and communicated by data producing nodes and independently operated on in data consuming nodes, data consuming nodes can separately generate and communicate the portions of the data to the data consuming nodes for performing the operations of the model.

In some embodiments, at least one electronic device (e.g., electronic device 400, etc.) or some portion thereof uses code and/or data stored on a non-transitory computer-readable storage medium to perform some or all of the operations described herein. More specifically, the at least one electronic device reads code and/or data from the computer-readable storage medium and executes the code and/or uses the data when performing the described operations. A computer-readable storage medium can be any device, medium, or combination thereof that stores code and/or data for use by an electronic device. For example, the computer-readable storage medium can include, but is not limited to, volatile and/or non-volatile memory, including flash memory, random access memory (e.g., DDR5 DRAM, SRAM, eDRAM, etc.), non-volatile RAM (e.g., phase change memory, ferroelectric random access memory, spin-transfer torque random access memory, magnetoresistive random access memory, etc.), read-only memory (ROM), and/or magnetic or optical storage mediums (e.g., disk drives, magnetic tape, CDs, DVDs, etc.).

In some embodiments, one or more hardware modules perform the operations described herein. For example, the hardware modules can include, but are not limited to, one or more central processing units (CPUs)/CPU cores, graphics processing units (GPUs)/GPU cores, application-specific integrated circuit (ASIC) chips, field-programmable gate arrays (FPGAs), compressors or encoders, encryption functional blocks, compute units, embedded processors, accelerated processing units (APUs), controllers, requesters, completers, network communication links, and/or other functional blocks. When circuitry (e.g., integrated circuit elements, discrete circuit elements, etc.) in such hardware modules is activated, the circuitry performs some or all of the operations. In some embodiments, the hardware modules include general purpose circuitry such as execution pipelines, compute or processing units, etc. that, upon executing instructions (e.g., program code, firmware, etc.), performs the operations. In some embodiments, the hardware modules include purpose-specific or dedicated circuitry that performs the operations “in hardware” and without executing instructions.

In some embodiments, a data structure representative of some or all of the functional blocks and circuit elements described herein (e.g., electronic device 400 or some portion thereof) is stored on a non-transitory computer-readable storage medium that includes a database or other data structure which can be read by an electronic device and used, directly or indirectly, to fabricate hardware including the functional blocks and circuit elements. For example, the data structure may be a behavioral-level description or register-transfer level (RTL) description of the hardware functionality in a high-level design language (HDL) such as Verilog or VHDL. The description may be read by a synthesis tool which may synthesize the description to produce a netlist including a list of transistors/circuit elements from a synthesis library that represent the functionality of the hardware including the above-described functional blocks and circuit elements. The netlist may then be placed and routed to produce a data set describing geometric shapes to be applied to masks. The masks may then be used in various semiconductor fabrication steps to produce a semiconductor circuit or circuits (e.g., integrated circuits) corresponding to the above-described functional blocks and circuit elements. Alternatively, the database on the computer accessible storage medium may be the netlist (with or without the synthesis library) or the data set, as desired, or Graphic Data System (GDS) II data.

In this description, variables or unspecified values (i.e., general descriptions of values without particular instances of the values) are represented by letters such as N, T, and X. As used herein, despite possibly using similar letters in different locations in this description, the variables and unspecified values in each case are not necessarily the same, i.e., there may be different variable amounts and values intended for some or all of the general variables and unspecified values. In other words, particular instances of N and any other letters used to represent variables and unspecified values in this description are not necessarily related to one another.

The expression “et cetera” or “etc.” as used herein is intended to present an and/or case, i.e., the equivalent of “at least one of” the elements in a list with which the etc. is associated. For example, in the statement “the electronic device performs a first operation, a second operation, etc.,” the electronic device performs at least one of the first operation, the second operation, and other operations. In addition, the elements in a list associated with an etc. are merely examples from among a set of examples—and at least some of the examples may not appear in some embodiments.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. An electronic device, comprising:
one or more data producing nodes; and
a data consuming node;
each data producing node is configured to:
separately generate two or more portions of a respective block of data; and
upon completing generating each portion of the two or more portions of the respective block of data, communicate that portion of the respective block of data to the data consuming node; and
the data consuming node is configured to:
upon receiving corresponding portions of the respective blocks of data from each of the one or more data producing nodes, perform operations for a model using the corresponding portions of the respective blocks of data.

2. The electronic device of claim 1, wherein the data consuming node is configured to perform the operations for the model using the corresponding portions of the respective blocks of data at substantially a same time as some or all of the data producing nodes are generating and/or communicating other portions of the respective blocks of data.

3. The electronic device of claim 1, wherein:
each data producing node includes a plurality of computational resources and a network interface; and
each data producing node is configured to dynamically allocate one or more computational resources for generating each portion of the two or more portions of the respective block of data, wherein at least one of the computational resources causes the communication of each portion of the respective block of data to the data consuming node via the network interface of that data producing node.

4. The electronic device of claim 1, wherein the data producing node and/or the data consuming node are configured to allocate computational resources including workgroups in a graphics processing unit (GPU) for performing respective operations.

5. The electronic device of claim 1, wherein a number of the two or more portions of the respective blocks of data is set to a specified value based on properties of the respective blocks of data, the data consuming node, and/or the one or more data producing nodes.

6. The electronic device of claim 1, wherein:
the model is a deep learning recommendation model (DLRM) and each of the data producing nodes is configured to store a subset of a set of embedding tables for the DLRM in a local memory in that data producing node; and
the respective block of data for each data producing node includes lookup data acquired from some or all of the subset of the set of embedding tables stored in the local memory in that data producing node and the portions of the respective block of data include a subset of the lookup data of the respective block of data for that data producing node.

7. The electronic device of claim 1, wherein:
the model is a DLRM and each of the data producing nodes is configured to store a subset of a set of embedding tables for the DLRM in a local memory in that data producing node; and
when performing the operations for the model using the corresponding portions of the respective blocks of data, the data consuming node is configured to combine lookup data received from each data producing node in the corresponding portions of the respective blocks of data with results from a bottom multilayer perceptron (MLP) to generate inputs for a top MLP for the DLRM.

8. The electronic device of claim 1, wherein:
the operations for the model include a matrix multiplication operation; and
the corresponding portions of the respective blocks of data include data upon which the matrix multiplication operation can be performed independently of other portions of the respective blocks of data.

9. The electronic device of claim 1, wherein:
the operations for the model include operations for using the data to generate results of the model while processing instances of input data through the model; and
the respective blocks of data include model data communicated from the one or more data producing nodes to the data consuming node as part of an all to all communication.

10. The electronic device of claim 1, wherein:
the operations for the model include operations for training the model; and
the respective blocks of data include training data communicated from the one or more data producing nodes to the data consuming node as part of an all-reduce communication.

11. A method for communicating data for a model between nodes in an electronic device that includes one or more data producing nodes and a data consuming node, the method comprising:
separately generating, by each data producing node, two or more portions of a respective block of data; and
upon completing generating each portion of the two or more portions of the respective block of data, communicating, by the each data producing node, that portion of the respective block of data to the data consuming node; and
upon receiving corresponding portions of the respective blocks of data from each of the one or more data producing nodes, performing, by the data consuming node, operations for a model using the corresponding portions of the respective blocks of data.

12. The method of claim 11, wherein the data consuming node performs the operations for the model using the corresponding portions of the respective blocks of data at substantially a same time as some or all of the data producing nodes are generating and/or communicating other portions of the respective blocks of data.

13. The method of claim 11, wherein:
each data producing node includes a plurality of computational resources and a network interface; and
the method further comprises dynamically allocating, by each data producing node, one or more computational resources for generating each portion of the two or more portions of the respective block of data, wherein at least one of the computational resources causes the communication of each portion of the respective block of data to the data consuming node via the network interface of that data producing node.

14. The method of claim 11, further comprising:
allocating, by the data producing node and/or the data consuming node, computational resources including workgroups in a graphics processing unit (GPU) for performing respective operations.

15. The method of claim 11, wherein a number of the two or more portions of the respective blocks of data is set to a specified value based on properties of the respective blocks of data, the data consuming node, and/or the one or more data producing nodes.

16. The method of claim 11, wherein:
the model is a deep learning recommendation model (DLRM) and each of the data producing nodes stores a subset of a set of embedding tables for the DLRM in a local memory in that data producing node; and
the respective block of data for each data producing node includes lookup data acquired from some or all of the subset of the set of embedding tables stored in the local memory in that data producing node and the portions of the respective block of data include a subset of the lookup data of the respective block of data for that data producing node.

17. The method of claim 11, wherein:
the model is a DLRM and each of the data producing nodes stores a subset of a set of embedding tables for the DLRM in a local memory in that data producing node; and
performing the operations for the model using the corresponding portions of the respective blocks of data includes combining lookup data received from each data producing node in the corresponding portions of the respective blocks of data with results from a bottom multilayer perceptron (MLP) to generate inputs for a top MLP for the DLRM.

18. The method of claim 11, wherein:
the operations for the model include a matrix multiplication operation; and
the corresponding portions of the respective blocks of data include data upon which the matrix multiplication operation can be performed independently of other portions of the respective blocks of data.

19. The method of claim 11, wherein:
the operations for the model include operations for using the data to generate results of the model while processing instances of input data through the model; and
the respective blocks of data include model data communicated from the one or more data producing nodes to the data consuming node as part of an all to all communication.

20. The method of claim 11, wherein:
the operations for the model include operations for training the model; and
the respective blocks of data include training data communicated from the one or more data producing nodes to the data consuming node as part of an all-reduce communication.
